(19) United States
(12) Patent Application Publication
(10) Pub. No.: US 2014/0134588 A1
(43) Pub. Date: May 15, 2014

(54) EDUCATIONAL TESTING NETWORK

(71) Applicants: Richard William Capone, Kensington, CA (US); Allan William Heaton, Bend, OR (US)

(72) Inventors: Richard William Capone, Kensington, CA (US); Allan William Heaton, Bend, OR (US)

(21) Appl. No.: 13/748,555

(22) Filed: Jan. 23, 2013

Related U.S. Application Data
(63) Continuation-in-part of application No. 11/936,068, filed on Nov. 6, 2007, now abandoned.
Application No. 11/936,068 is a continuation-in-part of application No. 13/297,267, filed on Nov. 16, 2011, now Pat. No. 8,478,185.
Application No. 13/297,267 is a continuation-in-part of application No. 11/340,873, filed on Jan. 26, 2006, now abandoned.
Application No. 11/340,873 is a continuation-in-part of application No. 11/340,874, filed on Jan. 26, 2006, now abandoned.

(51) Int. Cl. G09B 5/02

(52) U.S. Cl. CPC G09B 5/02
USPC 434/322

(57) ABSTRACT

Systems and methods are disclosed for serving fresh media content while minimizing Internet traffic by periodically checking content freshness between a local server and a remote server; if a stale content exists on the local server, replacing the stale content with a fresh content from the remote server; and serving the fresh content from the local server. The system also tests the student by adaptively modifying the predetermined testing level based on the diagnosis of each testing group and repeating tests at the adaptively modified predetermined testing level for a plurality of sub-tests.

This application is a continuation-in-part of Ser. No. 11/936,068 filed Nov. 6, 2007 and Ser. No. 13/297,267 filed Nov. 16, 2011 and application Ser. No. 11/340,873, filed on Jan. 26, 2006, which is also related to application Ser. No. 11/340,874, filed on Jan. 26, 2006, the contents of which are incorporated by reference.

### BACKGROUND

The present application relates to high speed file access for educational testing.

The advent of media rich digital content is changing the face of Internet applications. Various applications such as training and education require users to access media contents such as photographs, streaming audio and video, and training materials. Rich media streaming involves various types of media such as audio, video, text, and/or images.

For example, FIG. 1 shows an exemplary web application to client communication process for educational applications from Let's Go Learn. Content is streamed from an originating server 10 such as a server from an educational system called Let's Go Learn (www.letsgolearn.com). The content is streamed over a wide area network such as the Internet 12 to an end-user Internet connection point 20. The connection point 20 is in turn connected to a local area network (LAN) 21 and a plurality of user workstations 22 are connected to the LAN 21 to receive training materials originating from the server 10.

Media streaming involves various network conditions with different bandwidths and delays. In streaming, a receiving device reproduces sound or video in real time as the signal is downloaded over the Internet, as opposed to storing the signal in a local file first. A plug-in to a Web browser, such as Netscape Navigator, decompresses and plays the data as it is transferred to a personal computer over the Internet. Streaming audio or video avoids the delay entailed in downloading an entire file and then reproducing it with a helper application. Streaming requires a fast connection and a computer with sufficient processing capability to execute the decompression algorithm in real-time.

Computer networks, such as the Internet, now carry data for multimedia applications, which are particularly latency-sensitive, or vulnerable to delay. For example, a delay experienced during the transmission of video data interrupts the video enjoyment experience. In contrast, a delay in downloading a Web page is less problematic to the user. Conversely, voice transmission requires less bandwidth (bits per second) than receiving a Web page, for example, but does require an uninterrupted amount of bandwidth.

U.S. Pat. No. 6,671,732 discloses a method and an apparatus for tagging rich media content so that receivers of electronic information on electronic networks can specify content preferences. The transmission of content is controlled by the setting of priorities by the user, according to different forms of content, and then the system deletes content beginning with that of lowest priority. Content can be deleted because of poor communication conditions, or proactively to effectively highlight aspects of the communicated information in conformance to the desires of the user.

### SUMMARY

Systems and methods are disclosed for serving fresh media content while minimizing Internet traffic by periodically checking content freshness between a local server and a remote server. If stale content exists on the local server, the local server replaces stale content with fresh content from the remote server and serves the fresh content from the local server. The system also tests the student by: presenting a new concept to the student through a multimedia presentation; testing the student on the concept at a predetermined testing level; collecting test results for one or more concepts into a test result group; performing a formative diagnosis on the test result group to provide information to guide individualized instruction; and adaptively modifying the predetermined testing level based on the diagnosis of each testing group and repeating tests at the adaptively modified predetermined testing level for a plurality of sub-tests.

Advantages of the system may include one or more of the following. The system efficiently serves media files from a remote local network in place of downloading large media files over the Internet. By doing so, the system greatly reduces the Internet bandwidth requirement of the customer while still providing a content rich experience involving large multi-media files. The system works with existing network infrastructure. The system allows customers such as schools that have limited Internet bandwidth and/or heavily congested Internet usage during assessment times to operate more effectively. The system selectively serves static rich media files, which are usually large in file size, locally and will only send the assessment testing data or instructional-status data over the Internet connection. The net result will be that the Internet bandwidth usage will be greatly reduced. The assessment testing data or instructional-status data in turn provides educators, parents and employers with an immediate feedback, an ability to create and edit these tools at any time, anywhere, an ability to score and store the data in a remote location and to upload to a computer at a later time, and an ability to aggregate the data from multiple scorers.

Other advantages may include one or more of the following. The reading assessment and reading instruction systems allows the teacher to expand his or her reach to struggling readers and acts as a reading specialist when too few or none are available. The math assessment and math instructional systems allows the teacher to quickly diagnose the student's number and measurement skills and shows a detailed list of skills mastered by each math construct. Diagnostic data is provided to share with parents for home tutoring or with tutors or teachers for individualized instructions. Diagnostic data is used to provide direct online instruction that is differentiated for each student. All assessment reports are available at any time. Historical data is stored to track progress, and reports can be shared with tutors, teachers, or specialists. For parents, the reports can be used to tutor or teach your child yourself. The web-based system can be accessed at home or when away from home, with no complex software to install.

Other advantages and features will become apparent from the following description, including the drawings and claims.

### BRIEF DESCRIPTION OF THE DRAWINGS

Referring now to the drawings in greater detail, there is illustrated therein structure diagrams for an educational adaptive assessment and instruction system and logic flow diagrams for the processes a computer system will utilize to complete various educational or training transactions. It will be understood that the program is run on a computer that is capable of communication with consumers via a network, as will be more readily understood from a study of the diagrams.

FIG. 1 shows a conventional web application to client communication process.

FIG. 2 shows an exemplary system that accelerates rich media transmission.

FIG. 3 shows an exemplary operating process for the local media device.

FIG. 4 shows an exemplary rich media servicing process in accordance with one aspect of the system.

FIG. 5 shows an exemplary use case where the device 50 is on a top level customer LAN.

FIG. 6 shows another exemplary use case where multiple devices 50 are deployed on one or more low level customer LANs.

FIG. 7A shows an exemplary instruction process.

FIG. 7B shows an exemplary media rich process operative in an adaptive diagnostic assessment engine.

FIG. 8 shows an exemplary process through which an educational adaptive diagnostic assessment is generated to assess student performance.

FIG. 9 shows details of an exemplary adaptive diagnostic engine.

FIGS. 10A-10H show exemplary reading sub-test user interfaces (UIs), while FIG. 10I shows an exemplary summary report of the tests.

FIG. 11 shows an exemplary summary table showing student performance.

FIG. 12 shows another embodiment where the assessment is based on an assessment engine which provides diagnostic/formative assessment of students online.

FIG. 13 shows an exemplary summary report of the tests.

FIG. 14 shows an exemplary summary report to provide prescriptive instruction for each student.

### DESCRIPTION

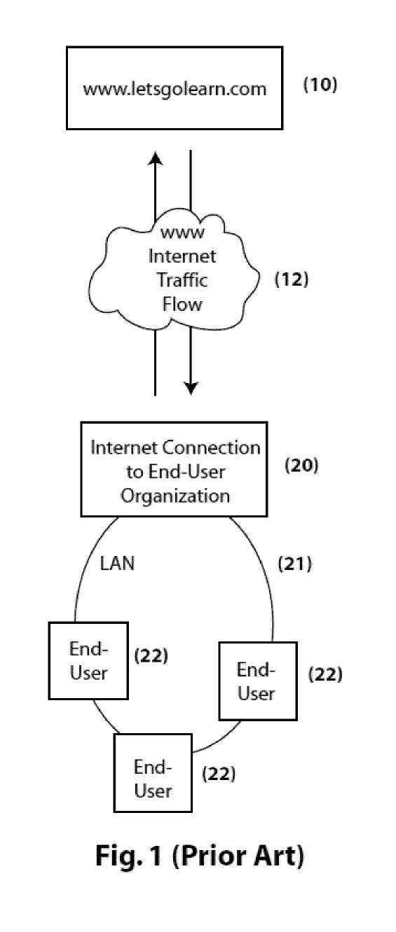

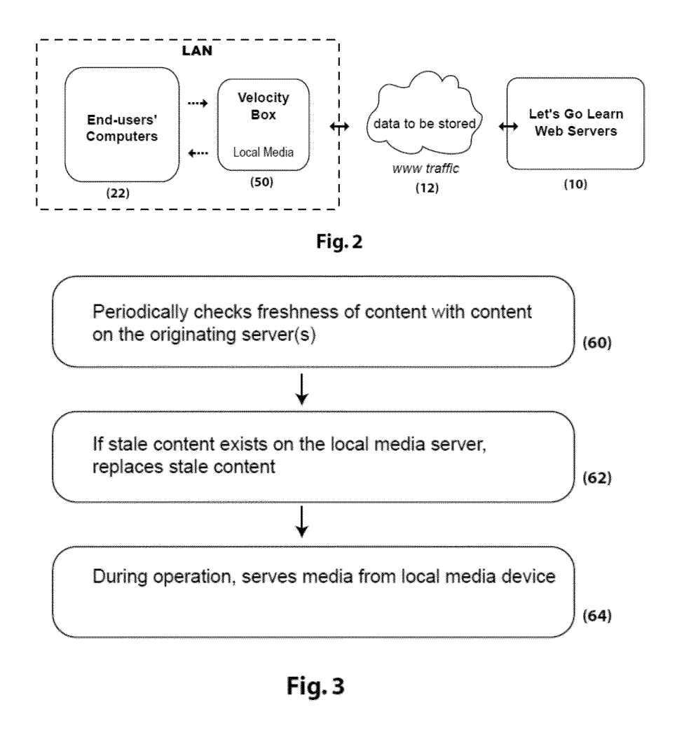

FIG. 2 shows an exemplary system that accelerates rich media transmission. In this system, a source or originating server 10 communicates data over the Internet 12 as is done in FIG. 1. However, a local media device 50 is inserted between the internet 12 and the end user workstations or computers 22.

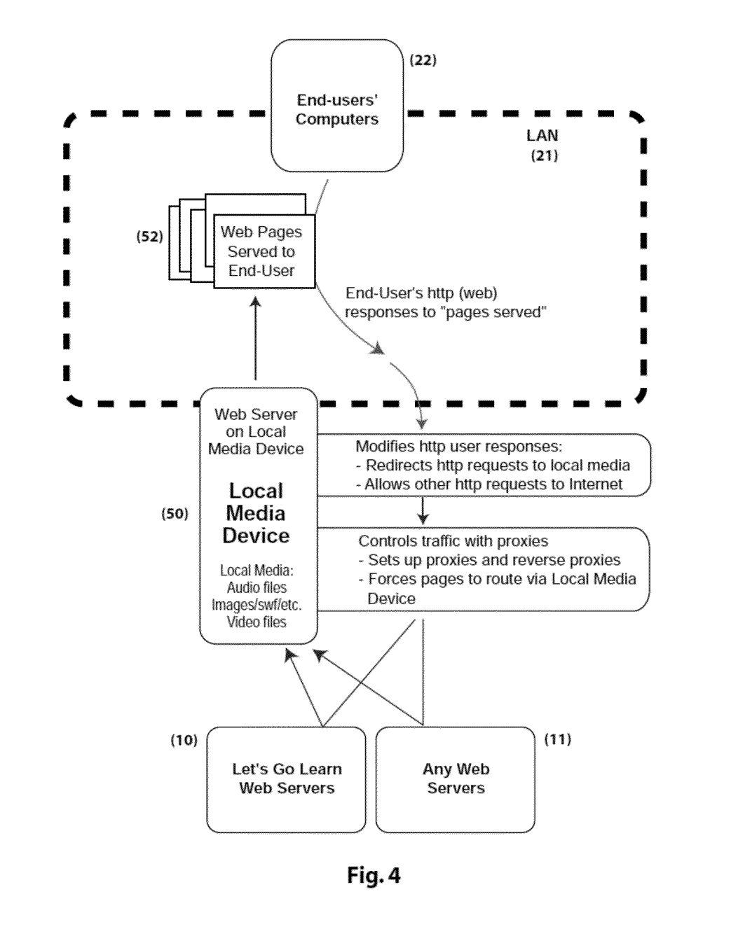

FIG. 3 shows an exemplary operating process for the local media device 50. The device 50 is initially provided with fresh media content and the device 50 serves content upon request from the end user workstations or computers 22. Over time, content on the originating server 10 is updated or otherwise enhanced, and a variance exists between the content on the local media device 50 and the originating server 10. To synchronize the content on the local media device 50 and the originating server 10, the local media device 50 periodically checks to see if its media content matches the time stamp or size (among others) of corresponding files on the originating server 10 (60). If differences exist, the local media device 50 replaces its stale content by copying the content of the originating server 10 to replace older content (62). The update operation can be done at night to minimize performance disruptions on the users. Once updated, media content is served by the local media device 50 in response to requests from end-user computers 22. Such local delivery of data reduces data transfer over the Internet 12. The reduced bandwidth requirement allows the originating server 10 to serve more LANs which in turn can service more clients.

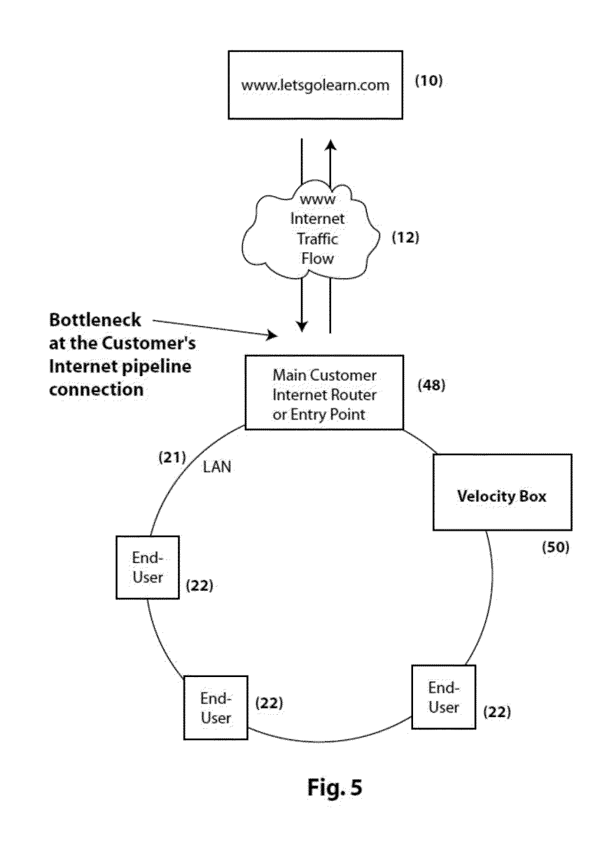

FIG. 4 shows an exemplary rich media servicing process in accordance with one aspect of the system. As discussed above, content from the originating server 10 or any other web servers 11 is sent to the local media device 50. The content can be audio files, images, flash content, or video files, for example. The device 50 includes a web server that serves web pages 52 to end-users at their computers 22. The end-user's web response (such as an http response) is sent back to the local media device 50. The device 50 modifies the user's web response to redirect rich media requests to the local media device 50 while allowing requests not directed at the rich media content to be forwarded to the Internet for other servers to respond to. Traffic is controlled through proxies. The device 50 sets up a proxy server and reverse proxy server and forces pages to route through the device 50. A proxy server is a server (a computer system or an application program) which services the requests of its clients by forwarding requests to other servers. A client connects to the proxy server, requesting some rich media service, such as a music file or video file, connection, web page, or other resource, available from a different server. The proxy server provides the resource by connecting to the specified server and requesting the service on behalf of the client. A proxy server may optionally alter the client's request or the server's response, and sometimes it may serve the request without contacting the specified server. A proxy server that passes all requests and replies unmodified is usually called a gateway or sometimes tunneling proxy. The proxy server can be placed in the user's local computer or at specific key points between the user and the destination servers or the Internet. A reverse proxy is called because it acts as a proxy for in-bound traffic to many servers hidden behind a single IP address (eg. a cluster of web servers all serving content for the same domain).

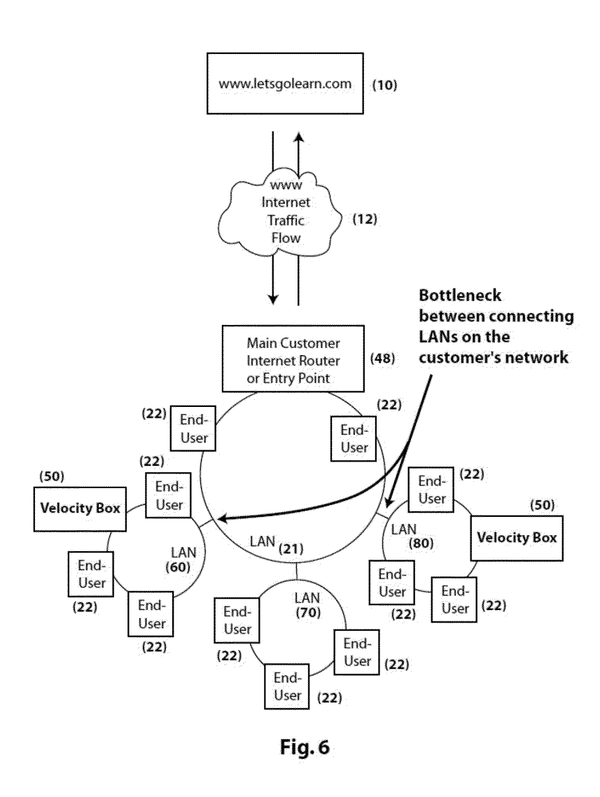

FIG. 5 shows an exemplary use case where the device 50 is on a top level customer LAN. In this system, the source or originating server 10 communicates data over the Internet 12. The data is received at a main customer Internet router or entry point 48 and provided to a LAN 21. The local media device 50 as well as a plurality of end user workstations or computers 22 are connected to the LAN. The device 50 acts as a local cache that serves rich media requests from its own data storage devices if the requests are directed at contents on the originating server 10. Otherwise, the local media device 50 forwards the request through the router or entry point 48 to its intended server. In this manner, the device 50 solves the bottleneck at the customer's Internet pipeline connection. The bottleneck is defined as the point in the end-user to web communication where the Internet communication is the most congested.

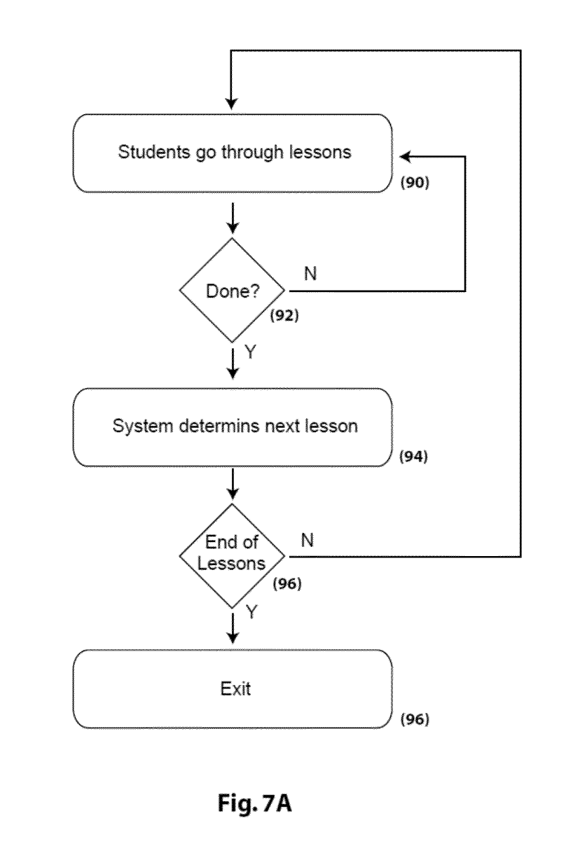

FIG. 6 shows another exemplary use case where multiple devices 50 are deployed on one or more low level customer LANs. In this embodiment, LAN 21 communicates with a plurality of lower level LANs 60, 70 and 80. In certain high load LANs such as LANs 60 and 80, the devices 50 are provided in each LAN to relieve the bottleneck therein. In certain other LANs such as LAN 70 where the load is not intensive, the LAN may not need the device 50. Hence, FIG. 6 shows a heterogeneous set of LANs which may or may not need dedicated local media devices 50.

During operation, a student logs on-line and based on the parameters, is presented with a presentation (instructions, lessons, etc.) and one or more follow-up questions selected from a set of questions. The presentation can be a multimedia presentation including sound, image, animation, video and text. The multimedia presentation or content is typically stored in the local server 50. However, the content may be periodically updated, and thus the local server 50 needs to periodically refresh its content by comparing and downloading revised content on the remote server 10.

The student is either tested for comprehension of the concept and the diagnostic engine presents additional questions in this concept based on the student's performance on earlier questions OR the student is given a lesson and based on his/her performance/completion is given follow up lessons. The process is repeated for additional concepts based on the test-taker's performance on earlier concepts. When it is determined that additional concepts do not need to be covered for a particular test-taker, the test halts. Prescriptive recommendations and diagnostic test results are compiled in real-time when requested by parents or teachers by data mining the raw data and summary scores of any student's particular assessment.

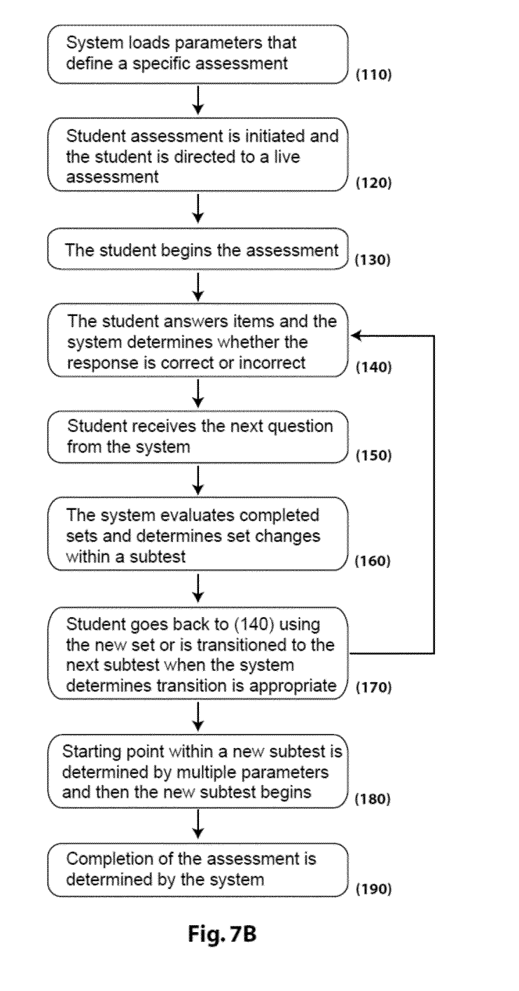

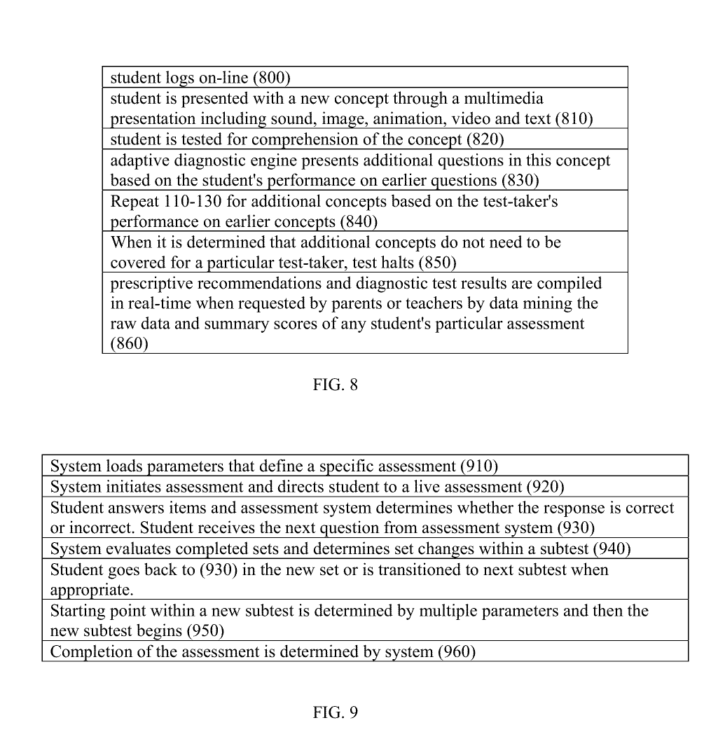

FIG. 7A shows an exemplary instructional process. The system paces the students through the current lesson (90). This is repeated until the student is done with the current lesson (92). If the student is done, the system determines the next lesson to be provided to the student (94). If there is another lesson to be done, the system presents the next lesson to the student by looping back to 90, and if the student has reached the end of lessons (96), the system exits.

In this manner, the students start with the first lesson. When the student is done with the first lesson, the system checks if the student is done with the current test so that the next lesson can be selected. The students go through the new lesson, and the process repeats until all lessons have been completed. The continue touching of the system at the completion of each lesson is necessary so the system knows how the students are doing and redirect the student in case the teacher changed the student's lesson plan or the student's performance warrants a change.

FIG. 7B shows an exemplary media rich process operative in an adaptive diagnostic assessment engine. In this process, the engine receives parameters that define a specific assessment (110). Among others, the parameters can include one or more of the following:
1) number of subtests in an assessment
2) number of sets per subtest
3) number of questions per set (can be variable between sets)
4) student parameters to use to determine assessment starting point
   a. i.e. grade level of student, age of student
   b. i.e. previous summary scores of student
5) transition between subtest parameters which determines how student will transition from one subtest to the next and whether subtests may be skipped or included.
6) Movement within a subtest which examines how students are moved within a subtest based on their performance on any particular set or multiple sets.
7) Termination conditions for each subtest and for the entire assessment
8) Graphical interface parameters such as trigger conditions for loading particular learning modules on the student's computer to deliver the questions and answers.
9) Audio parameters which determine audio file versions to be presented to a particular test-taker. For example, younger test-takers hear simple instructions and more motivational words while older test-takers hear more straight forward instructions that may use language at a higher grade level.
10) Summary score formula from each subtest if it is being scored.

Once parameters have been loaded, a student assessment test is initiated and the student is directed to a live assessment (120). The student enters the system through three pathways: For example, the student can log-in using a valid student log-in and password directly into the system. A teacher who is already logged into a teacher management application can allow the student to begins or continue a student assessment. Third-party companies who are suitably authorized can initiate an external account handshake which delivers a student directly into the system. This one way communication sends student information and a security key code. In real-time validation occurs and the assessment is begun.

The assessment process is initiated and a presentation and/or a question is presented to the student (130). The assessment can be based on his/her grade level, age, student type, or previous test scores from a completed assessment of the same type. The student responds with answers to questions or items and the system determines whether the student's response is correct or incorrect (140).

Any of the following conditions or all may be used to determine whether a response is correct or incorrect: 1) the system can compare the multiple choice question's answer to the student's multiple choice selection; 2) the system can compare a typed student response and compare the typed response to a question's correct answer for exact and/or partial match conditions; and 3) the system can examine student response time and compare the response time to a time limit conditions.

The student receives the next question from the system (150) and the system evaluates completed sets and determines set changes within a subtest (160). Sets can be made up of one or more questions. For example, the sets can be based on a percentage of correct responses in a set can move students to high or lower sets at variable jump sizes. The set can also be selected based on results from other completed or partially completed subtests can affect set changes in this current subtest. Alternatively, ceiling conditions determined by student's age, grade, type can affect set changes.

The student goes back to step four in the new set or is transitioned to next subtest when the system determines transitions appropriate (170). The following conditions may be used to determine when a transition should occur:
1) Mastery of a set is determined by specific assessment subtest parameters.
2) Adjacent set results of a mastered set above a non-mastered set can trigger termination of a subtest
3) Pattern of mastery and/or non-mastery of adjacent sets can determine termination of a subtest.
4) Completion of highest level set within a subtest can determine termination of a subtest.
5) Total number of errors in a set may trigger termination of a subtest.
6) Pattern of errors of a subtest may trigger termination of a subtest.

A starting point within a new subtest is determined by multiple parameters and then the new subtest begins (180). In one embodiment, the following are parameters may be used: 1) summary scores of a completed/terminated earlier subtest in the same assessment; 2) summary score of the same subtest in an earlier administered completed assessment; or calculations on multiple summary scores on multiple subtests that have just been completed in the same assessment.

The system determines whether the assessment is completed (190). Various conditions can affect the completion of the assessment. For example, if all subtests have been completed, skipped, or terminated the assessment is finished. Alternatively, if all subtests that have been marked by the test administrator or teacher have been completed then the assessment is finished. This is for the cases where test administrators may target only certain subtests to be given in an assessment that contains multiple subtests.

Optionally, the students who completed the assessment may be sent to a reward page that rewards him/her with entertaining graphics for completing the assessment. The rewards page is selected based on the student's age, grade, type, and assessment type. The student can also transferred to one of the following: a log out page; an instructional program related to the assessment and uses the data for differentiation; a third party student management system from where the student originated; or a summary page that provides the student with prescriptive or summary information on his or her assessment results.

One embodiment of FIG. 7 is an Online Adaptive Assessment System for Individual Students (OAASIS). The OAASIS assessment engine resides on a single or multiple application server accessible via the web or network. It controls the logic of how students are assessed. It is independent of the subject being tested. Assessments are defined to OAASIS via a series of parameters that control how adaptive decisions are made while student are taking an assessment in real-time. Furthermore, OAASIS references multiple database tables that hold the actual test times. OAASIS will pull from various tables as it reacts to answers from the test-taker. During use OAASIS can work across multiple computer processors on multiple servers. Students can perform an assessment and in real-time OAASIS will distribute its load to any available CPU.

The above embodiment of the adaptive diagnostic engine is an expert system that adaptively determines the set of questions to be presented to the student based on his or her prior performance. The expert system is based on rules that are communicated as parameters to the engine prior to running the assessment. Instead of the expert system, other data mining systems can be used. For example, in one embodiment, manual classification techniques can be used. Manual classification requires individuals to assign each output to one or more categories. These individuals are usually domain experts who are thoroughly versed in the category structure or taxonomy being used. In other embodiments, an automated classifier can be used to mine data arising from the test results. The classifier is a k-Nearest-Neighbor (kNN) based prediction system. The prediction can also be done using Bayesian algorithm, support vector machines (SVM) or other supervised learning techniques. The supervised learning technique requires a human subject-expert to initiate the learning process by manually classifying or assigning a number of training data sets of image characteristics to each category. This classification system first analyzes the statistical occurrences of each desired output and then constructs a model or “classifier” for each category that is used to classify subsequent data automatically. The system refines its model, in a sense “learning” the categories as new images are processed. Alternatively, unsupervised learning systems can be used. Unsupervised Learning systems identify groups or clusters of related image characteristics as well as the relationships between these clusters. Commonly referred to as clustering, this approach eliminates the need for training sets because it does not require a preexisting taxonomy or category structure.

### DESCRIPTION

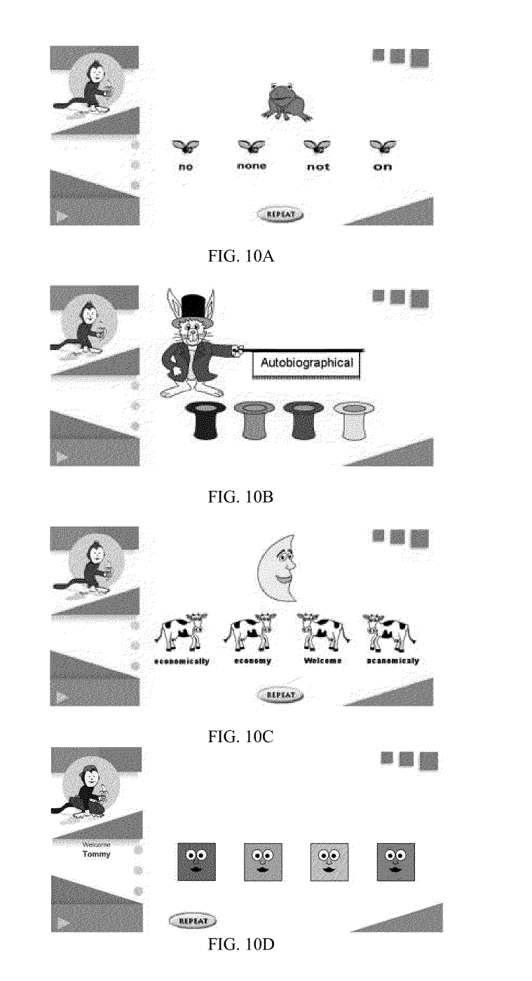

FIG. 8 shows an exemplary process through which an adaptive diagnostic assessment is generated to assess student performance. The system of FIG. 8 provides tests or assessments that can provide expanded information on an individual student called formative assessments or diagnostic assessments. Diagnostic or formative assessments provide information about individual students that will guide individualized instruction.

The diagnostic assessment system of FIG. 8 can be used to provide concrete information about the student's learning progress which in turn will lead to concrete conclusions about how best to teach a particular student. This diagnostic assessment system can determine whether test results support a valid conclusion about a student's level of skill knowledge or cognitive abilities. A diagnostic assessment can cover various aspects of reading or mathematical knowledge: skills, conceptual understanding, and problem solving. Melding together these different types of student knowledge and abilities is important in coming to understand what students know and how they approach individual cognitive tasks such as reading or performing problem solving activities. Two types of assessment essentially exist in the education field: summative assessment and formative or diagnostic assessment.

A summative assessment system is used to draw conclusions about groups of students. While specific skills may be targeted that are helpful in developing an individual student lesson plan, summative assessments do not cover enough skills to draw an accurate conclusion about individual students. This is the reason that summative assessments are NOT diagnostic. A teacher cannot concretely make individual student decisions because the information is not complete. The primary goal of a summative assessment is to take a snap shot at a particular point in time, roll the data up to the classroom, school, district, or state level, and then provide a benchmark for comparing groups of students. For example, third grade State of California Language Arts benchmark 2.5 states “Student will distinguish the main idea and supporting details in expository text.” A summative assessment might conclude that the student missed this item therefore the conclusion is to teach the student the main idea comprehension strategy. But this is a false assumption. A diagnostic assessment would see that the student missed this item but also test the student's decoding ability and grade level vocabulary. If the student was able to decode at grade level but had low vocabulary, the teacher would realize that the student does not have the ability to understand the main idea comprehension strategy because he or she cannot understand many words in the test passage. Thus, only by following up with additional measures can a teacher conclude the correct learning path for a student. This is provided by diagnostic assessment which can accurately make a conclusion on the student's learning path. If the information is too sparse then the assessment is only a summative assessment.

Turning now to FIG. 8, a student logs on-line (800). The student is presented with a new concept through a multimedia presentation including sound, image, animation, video and text (810). The student is tested for comprehension of the concept (820). An adaptive diagnostic engine presents additional questions in this concept based on the student's performance on earlier questions (830). The process is repeated for additional concepts based on the test-taker's performance on earlier concepts (840). When it is determined that additional concepts do not need to be covered for a particular test-taker, the test halts (850). Prescriptive recommendations and diagnostic test results are compiled in real-time when requested by parents or teachers by data mining the raw data and summary scores of any student's particular assessment (860).

In another implementation, a learning level initially is set to a default value or to a previously stored value. For example, the learning level can correspond to a difficulty level for the student. Based, on the currently set learning level, the student is presented with a new concept through a multimedia presentation including sound, image, animation, video and text. After the multimedia presentation, the student is tested for comprehension of the concept and the process is repeated for a predetermined number of concepts. For example, student performance is collected for every five concepts and then the results of the tests are provided to an adaptive diagnostic assessment engine. A learning level is adjusted based on the adaptive diagnostic assessment and the student is tested at the new level. Thus, the process encourages the student to learn and to be tested at new learning levels. When the battery of tests is eventually completed, the adaptive diagnostic assessment engine prints results and recommendations for users such as educators and parents.

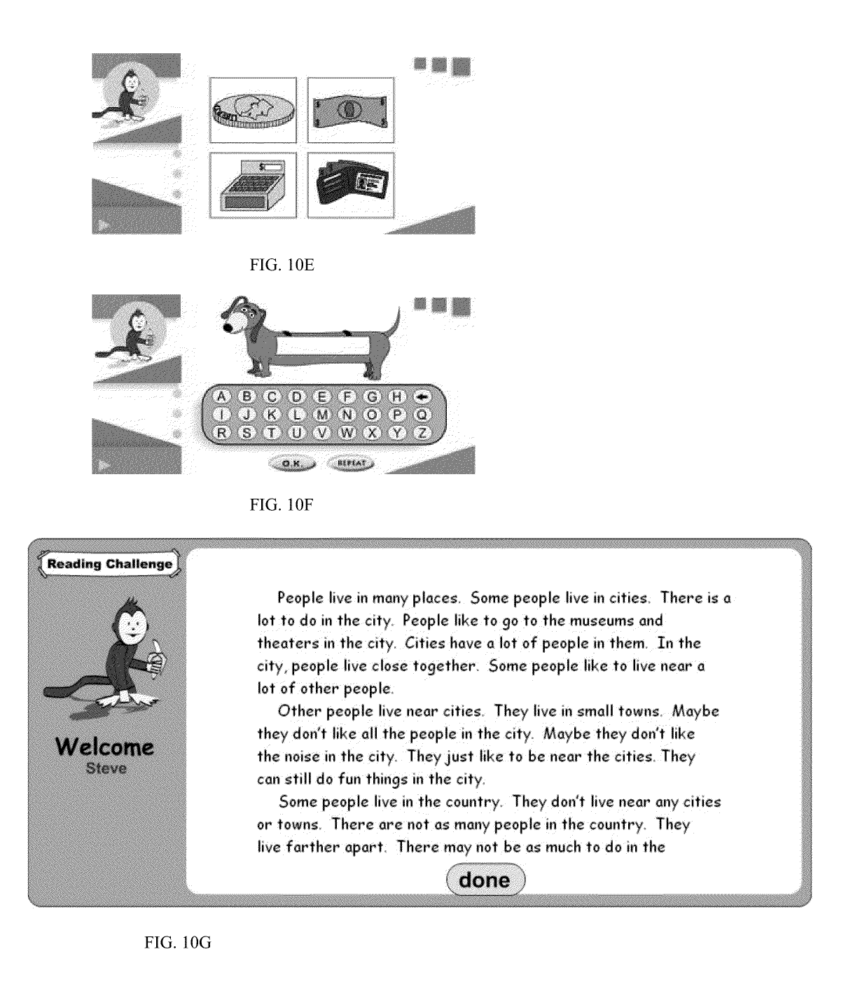

FIG. 9 shows an exemplary adaptive diagnostic assessment engine. In FIG. 9, the system loads parameters that define a specific assessment (910). The student can start the assessment or continue a previously unfinished assessment. Student's unique values determine his/her exact starting point, and based on the student's values, the system initiates assessment and directs student to a live assessment (920). The student answers items and assessment system determines whether the response is correct or incorrect and then present the next question from assessment system to the system (930). The system evaluates the completed sets and determines changes such as changes to the difficulty level by selecting a new set of questions within a subtest (940). The student goes back to (930) to continue the assessment process with a new set or is transitioned to next subtest when appropriate. A starting point within a new subtest is determined by multiple parameters and then the new subtest begins (950). The system continues testing the student until a completion of the assessment is determined by system (960).

One embodiment of FIG. 8 is called Online Adaptive Assessment System for Individual Students (OAASIS). The OAASIS assessment engine resides on a single or multiple application server accessible via the web or network. OAASIS controls the logic of how students are assessed and is independent of the subject being tested. Assessments are defined to OAASIS via a series of parameters that control how adaptive decisions are made while student are taking an assessment in real-time. Furthermore, OAASIS references multiple database tables that hold the actual test times. OAASIS will pull from various tables as it reacts to answers from the test-taker. During use OAASIS can work across multiple computer processors on multiple servers. Students can perform an assessment and in real-time OAASIS will distribute its load to any available CPU.

In one embodiment, the engine of FIG. 8 is configured to perform Diagnostic Online Reading Assessment (DORA) where the system assesses students' skills in reading by looking at seven specific reading measures. Initial commencement of DORA is determined by the age, grade, or previously completed assessment of the student. Once the student begins, DORA looks at his or her responses to determine the next question to be presented, the next set, or the next subtest. The three subtests deal with the decoding abilities of a student, high-frequency words, word recognition, and phonics (or word analysis) examine at how students decode words. The performance of the student on each subtest as they are presented affects how he or she will transition to the next subtest. For example a student who performs below grade level on the first high-frequency word subtest will start at a set below his or her grade level in word recognition. The overall performance on the first three subtests as well as the student's grade level will determine whether the fourth subtest, phonemic awareness is presented or skipped. For example students who perform at third or above grade level in high-frequency word, word recognition, and phonics will skip the phonemic awareness subtest. But if the student is at the kindergarten through second grade level he or she will perform the phonemic awareness subtest regardless of his or her performance on the first three subtests. Phonemic awareness is an audio only subtest. See FIG. 3D. This means the student doesn't have to have any reading ability to respond to its questions. The next subtest is word meaning also called oral vocabulary. It measures a student's oral vocabulary. Its starting point is determined by the student's age and scores on earlier subtests. Spelling is the sixth subtest. Its starting point is also determined by earlier subtests. The final subtest is reading comprehension also called silent reading. The starting point is determined by the performance of the student on word recognition and word meaning. On any subtest, student performance is measured as they progress through items. If test items are determined to be too difficult or too easy jumps to easier or more difficult items may be triggered. Also in some cases the last two subtests of spelling and silent reading may be skipped if the student is not able to read independently. This is determined by subtests one to three.

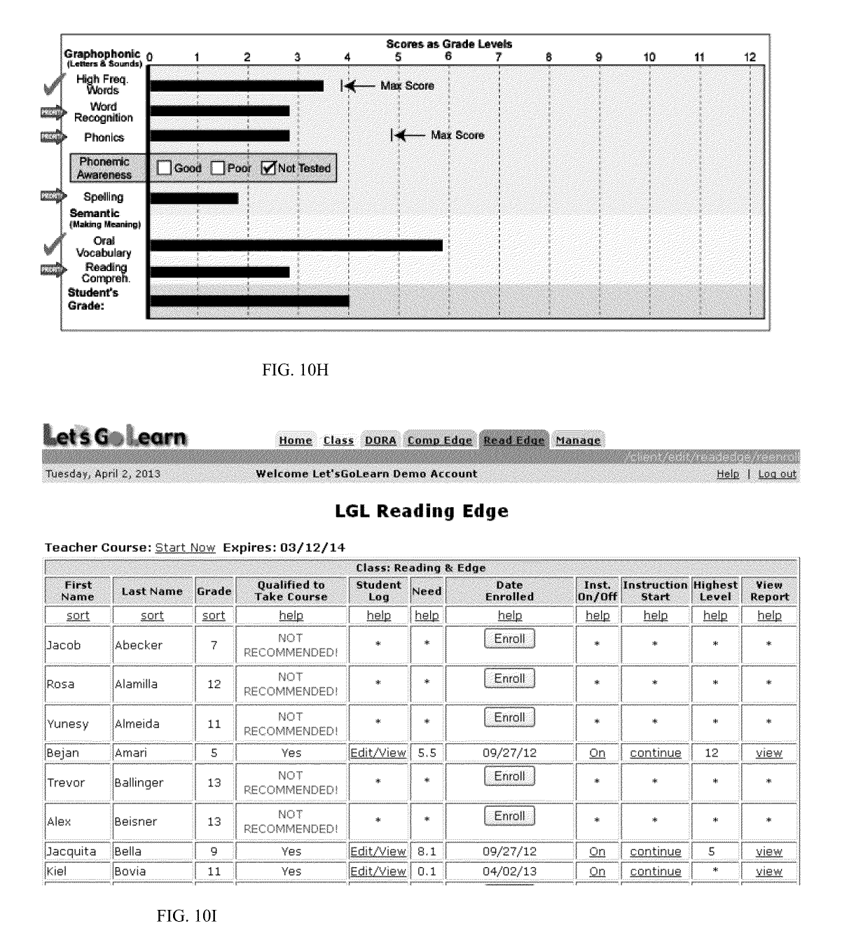

FIGS. 10A-10G show an exemplary reading test and assessment system that includes a plurality of sub-tests. Turning now to FIG. 3A, an exemplary user interface for a High Frequency Words Sub-test is shown. This subtest examines the learner's recognition of a basic sight-word vocabulary. Sight words are everyday words that people see when reading, often called words of “most-frequent-occurrence.” Many of these words are phonetically irregular (words that cannot be sounded out) and must be memorized. High-frequency words like the, who, what and those make up an enormous percentage of the material for beginning readers. In this subtest, a learner will hear a word and then see four words of similar spelling. The learner will click on the correct word. This test extends through third-grade difficulty, allowing a measurement of fundamental high-frequency word recognition skills.

FIG. 10B shows an exemplary user interface for a Word Recognition Subtest. This subtest measures the learner's ability to recognize a variety of phonetically regular (able to be sounded out) and phonetically irregular (not able to be sounded out) words. This test consists of words from first-grade to twelfth-grade difficulty. These are words that readers become familiar with as they progress through school. This test is made up of words that may not occur as often as high-frequency words but which do appear on a regular basis. Words like tree and dog appear on lower-level lists while ones like different and special appear on higher-level lists. In this subtest, a learner will see a word and hear four others of similar sound. The learner will click on a graphic representing the correct reading of the word in the text.

FIG. 10C shows an exemplary user interface for a Word Analysis Subtest. This subtest is made up of questions evaluating the learner's ability to recognize parts of words and sound words out. The skills tested range from the most rudimentary (consonant sounds) to the most complex (pattern recognition of multi-syllabic words). This test examines reading strategies that align with first-through fourth-grade ability levels. Unlike the previous two tests, this test focuses on the details of sounding out a word. Nonsense words are often used to reduce the possibility that the learner may already have committed certain words to memory. This test will create a measurement of the learner's ability to sound out phonetically regular words. In this subtest, the learner will hear a word and then see four others of similar spelling. The learner will click on the correct word.

FIG. 10D shows an exemplary user interface for a Phonemic Awareness Subtest. This subtest is made up of questions that evaluate the learner's ability to manipulate sounds that are within words. The learner's response is to choose from a choice of 4 different audio choices. Thus this Subtest doesn't require reading skills of the learner. The learner hears a word and is given instructions via audio. Then the learner hears 4 audio choices played aloud that correspond to 4 icons. The learner clicks on the icon that represents the correct audio answer.

FIG. 10E shows an exemplary user interface for a Word Meaning Subtest. This subtest is designed to measure the learner's receptive oral vocabulary skills. Unlike expressive oral vocabulary (the ability to use words when speaking or writing), receptive oral vocabulary is the ability to understand words that are presented orally. In this test of receptive oral vocabulary, learners will be presented with four pictures, will hear a word spoken, and will then click on the picture that matches the word they heard. For example, the learners may see a picture of an elephant, a deer, a unicorn and a ram. At the same time as they hear the word tusk, they should click on the picture of the elephant. All the animals have some kind of horn, but the picture of the elephant best matches the target word. This test extends to a twelfth-grade level. It evaluates a skill that is indispensable to the learner's ability to comprehend and read contextually, as successful contextual reading requires an adequate vocabulary.

FIG. 10F shows an exemplary user interface for a Spelling Subtest. This subtest will assess the learner's spelling skills. Unlike some traditional spelling assessments, this subtest will not be multiple-choice. It will consist of words graded from levels one through twelve. Learners will type the letters on the web page and their mistakes will be tracked. This will give a measure of correct spellings as well as of phonetic and non-phonetic errors.

FIG. 10G shows an exemplary user interface for a Silent Reading Subtest. This subtest, made up of eight graded passages with comprehension questions, will evaluate the learner's ability to respond to questions about a silently read story. Included are a variety of both factual and conceptual comprehension questions. For example, one question may ask, “Where did the boy sail the boat?” while the next one asks, “Why do you think the boy wanted to paint the boat red?” This test measures the learner's reading rate in addition to his or her understanding of the story.

Once the learner has completed the six sections of the assessment, a report as exemplified in FIG. 3H becomes available for online viewing or printing by the master account holder or by any properly authorized subordinate account holder. The report provides either a quick summary view or a lengthy view with rich supporting information. In this example, a particular student's performance is displayed in each sub-skill. The graph shown in FIG. 3H relates each sub-skill to grade level. Sub-skills one year or more behind grade level are marked by a “priority arrow.” At a glance, in Spelling and Silent Reading, the student is one or more years behind grade level. These skills constitute the priority areas on which to focus teaching remediation, as indicated by the arrows. In practice, no student is exactly the same as another. A reader's skill can vary across the entire spectrum of possibilities. This reflects the diverse nature of the reading process and demonstrates that mastering reading can be a complicated experience for any student. Thus, the Reading Assessment embodiment of FIG. 3H diagnostically examines six fundamental reading subskills to provide a map for targeted reading instruction.

After completing an assessment, students can be automatically placed into four instructional courses that target the five skill areas identified by the National Reading Panel. Teachers can modify students' placement into the instructional courses in real-time. Teachers can simply and easily repeat, change, or turn off lessons. The five skills are phonemic awareness, phonics, fluency, vocabulary, and comprehension. In phonemic awareness: the system examines a student's phonemic awareness by assessing his or her ability to distinguish and identify sounds in spoken words. Students hear a series of real and nonsense words and are asked to select the correct printed word from among several distracters. Lessons that target this skill are available for student instruction based upon performance. In phonics, the system assesses a student's knowledge of letter patterns and the sounds they represent through a series of criterion-referenced word sets. Phonetic patterns assessed move from short vowel, long vowel, and consonant blends on to diphthongs, vowel diagraphs, and decodable, multi-syllabic words. Lessons that target this skill are available for student instruction based upon performance. In fluency, the system assesses a student's abilities in this key reading foundation area. The capacity to read text fluently is largely a function of the reader's ability to automatically identify familiar words and successfully decode less familiar words. Lessons that target this skill are available for student instruction based upon performance. In vocabulary, the system assesses a student's oral vocabulary, a foundation skill critical to reading comprehension. Lessons that target this skill are available for student instruction based upon performance.

In other embodiments, the system assesses a student's ability to make meaning of short passages of text. Additional diagnostic data is gathered by examining the nature of errors students make when answering questions (e.g. the ratio of factual to inferential questions correctly answered). Lessons that target this skill are available for student instruction based upon performance.

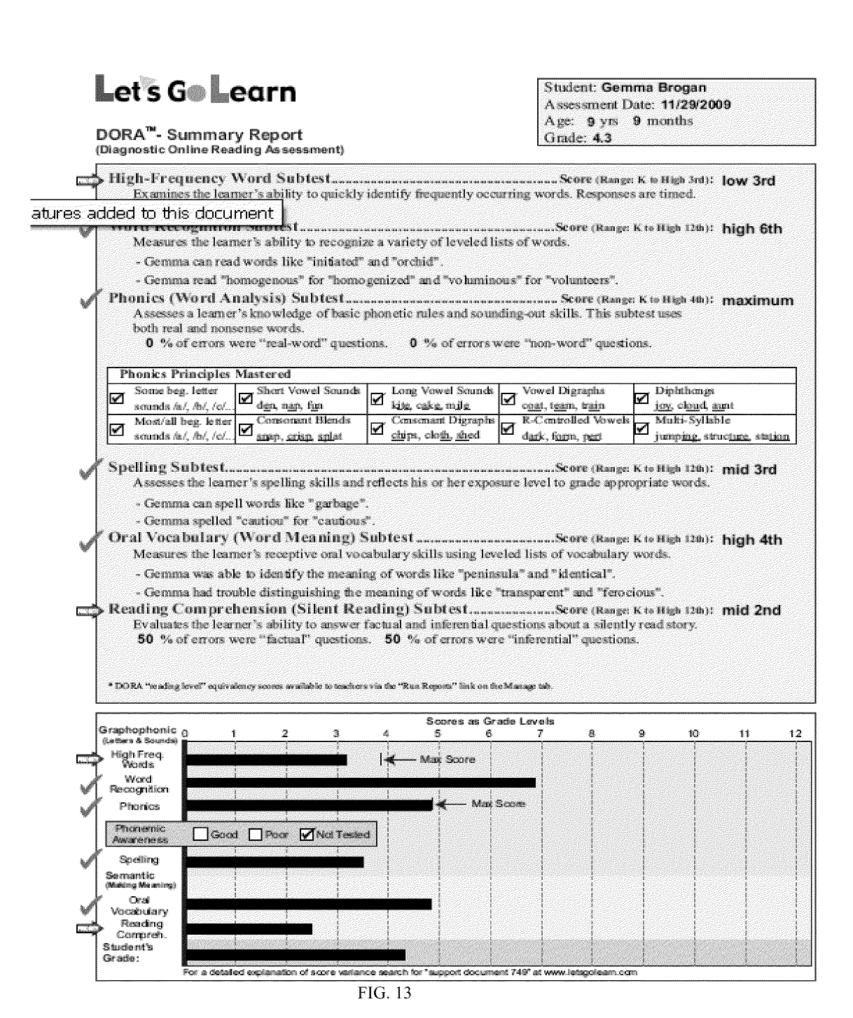

High-quality PDF reports can be e-mailed or printed and delivered to parents. FIG. 13 shows an exemplary summary report of the tests. These summary and full detailed reports inform the parents of their children's individual performance as well as guide instruction in the home setting. The report generated by the system assists schools in intervening before a child's lack of literacy skills causes irreparable damage to the child's ability to succeed in school and in life. Classroom teachers are supported by providing them with individualized information on each of their students and ways they can meet the needs of these individual students. Teachers can sort and manipulate the assessment information on their students in multiple ways. For example, they can view the whole classroom's assessment information on a single page or view detailed diagnostic information for each student.

The reading assessment program shows seven core reading sub-skills in a table that will facilitate the instructor's student grouping decisions. The online instruction option allows teachers to supplement their existing reading curriculum with individualized online reading instruction when they want to work with the classroom as a group but also want to provide one-on-one support to certain individual students. Once a student completes the assessment, the system determines the course his or her supplemental reading instruction might most productively take.

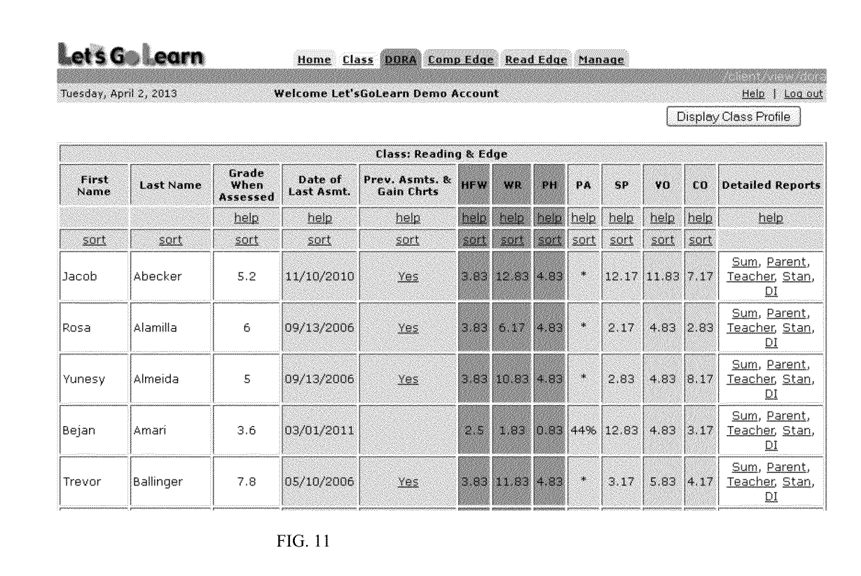

FIG. 11 shows a table view seen by teachers or specialists who log in. Their list of students can be sorted by individual reading sub-skills. This allows for easy sorting for effective small-group instruction and saves valuable class time. Students begin with instruction that is appropriate to their particular reading profiles as suggested by the online assessment. Depending on their profiles, students may be given all lessons across the four direct instructional courses or they may be placed into the one to three courses in which they need supplemental reading instruction.

One embodiment is run using a server as an educational portal that provides a single point of integration, access, and navigation through the multiple enterprise systems and information sources facing knowledge users operating the client workstations. The server enables the student to be educated with both school and home supervision. The process begins with the reader's current skills, strategies, and knowledge and then builds from these to develop more sophisticated skills, strategies, and knowledge across the five critical areas such as areas identified by the No Child Left Behind legislation. The system helps parents by bridging the gap between the classroom and the home. The system produces a version of the reading assessment report that the teacher can share with parents. This report explains to parents in a straightforward manner the nature of their children's reading abilities. It also provides instructional suggestions that parents can use at home.

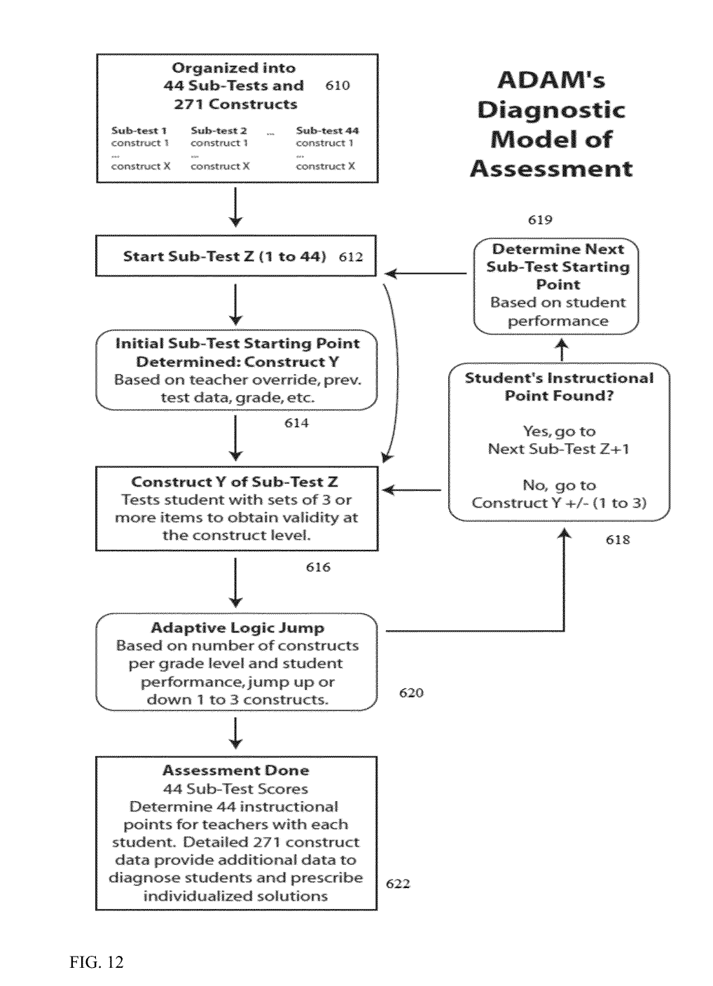

FIG. 12 shows another embodiment known as ADAM where the assessment is based on the same Let's Go Learn assessment engine (OAASIS) which provides diagnostic/formative assessment of students online. In this embodiment, tests are organized into 44 sub-tests and 271 constructs (610). The process starts sub-tests (612). An initial sub-test starting point is selected based on teacher preference, prior test results and grade, among others (614). Next, the process constructs a number of sub-tests such as testing students with sets of 3 or more items to obtain validity at a construct level (616). The system then performs an adaptive logic jump based on the number of constructs per grade level and student performance, among others, and moves up or down a predetermined number of constructs (620). The system then determines if the student's instruction point has been found (618). If not, the system varies the construct by a predetermined number of points and moves to 616. Alternatively, if the instruction point is found, the system determines the next sub-test starting point based on student performance (619) and loops back to 612. Once finished, the system determines the instructional points for teachers on each student. A detailed construction data is provided to help diagnose students and prescribe individual solutions.

Unlike all other assessments, ADAM assesses students online and in a manner that provides a thorough prescriptive diagnosis rather than simply reporting how students are performing against state standards or the national common core standards. Today, there are many assessments that advertise that they are diagnostic but if they are built on these state and common core standards they cannot truly be diagnostic because these standards are summative in nature, meaning they represent performance objectives by student grade levels. In other words, they define what each state and now the nation expect students to be able to do at each grade level. Diagnostic assessments like ADAM go beyond these standards and find out what foundation skills need to be taken in order to bring students up to grade level. For instance, sometimes students many not be able to do probability math problems at their grade level because they don't have the underlying foundation skill such as understanding fractions in order to do probability problem. In this case, a standards/summative based assessment would say that the student needs to be taught probability. ADAM however would uncover that the true problem is that the student lacks an understanding of fractions and then would identify where in the linear path of fractions instruction the student is at. What we are claiming is that ADAM is based on a pedagogy of mathematics that is not standards-based. This model is in essence a process that ADAM uniquely uses as it assesses students. Furthermore, the adaptive algorithms that ADAM uses are unique.

ADAM uniquely organizes and assesses students in mathematics by creating the following 44 sub-tests of mathematics and 271 math constructs. The 44-sub-tests break out into multiple constructs that are organized from easiest to hardest. This linear organization of the constructs corresponds to the way in which math is taught and thus uniquely aligns ADAM diagnosis directly to instruction. This alignment to an instructional model is unique since all other online assessments today are aligned to summative standards such as the common core and individual state instructional standards. The 44 sub-tests and 271 constructs in one embodiment are listed below:

| Sub-Test | Construct |
|---|---|
| Numbers | Numerals |
| | Counting Backwards |
| | Cardinal & Ordinal #'s |
| | Numerals (2 digit) |
| | Counting (by 1s 2s 3s 5s and 10s) |
| | Text and Numerals |
| | Counting (by hundreds and thousands) |
| | Comma & Place Holder |
| | Rounding |
| | Rounding (10s, 100s, 1,000s) |
| Place Value | Place Value |
| | Place Value |
| | Place Value (Thousand, Ten Thousand and Hundred Thousand) |
| | Place Value - Expanded Form |
| | Place Value (Thousand, Ten Thousand, Hundred Thousand, Millions) |
| | Place Value. Decimals. |
| Comparing and | Comparing (0-10) |
| Ordering | Comparing Using Symbols (2-digits) |
| | Comparing Using Symbols (3-digits) |
| | Money (equiv and non-equiv numbers using money) |
| | Comparing & Ordering |
| | Decimals (Comparing & Ordering) |
| Addition of | Modeling addition and subtraction with objects |
| Whole Numbers | Addition- Equivalent Forms |
| | Addition- (to 10) |
| | Addition (2-digit + 1-digit) |
| | Multi-digit Addition (non-regrouping) |
| | Addition (Regrouping) |
| | Addition (Multiple Digits) |
| Subtraction of | Subtracting from 10 |
| Whole Numbers | Multi-digit Subtraction (non-regrouping) |
| | Subtraction (Regrouping) |
| Multiplication of | Multiplication Readiness (grouping and repeated addition) |
| Whole Numbers | Multiplication Facts (Factors of 0 and 1) |
| | Multiplication Facts |
| | Multiplication (Powers of Ten) |
| | Multiplication (Commutative, Associative, Distributed) |
| | Multiplication (Two digit numbers by a single digit) |
| | Multiplication (Three digit numbers by a single digit numbers) |
| | Multiplication (Two and three digit numbers by a two digit) |
| | Multiplication (Commutative, Associative, Distributed) |
| Division of | Modeling Division as the Inverse of Multiplication |
| Whole Numbers | Division (Single diget divisor and Remainders) |
| | Division Facts |
| | Division (Whole Numbers) |
| | Division (four digits) |
| Fractions | Partitioning objects into parts |
| | Fractions (Representing fractions, comparing fractions, |
| | like denom or num) |
| | Fractions (as parts of sets |
| | Fraction (equivalent fractions) |
| | Fractions (Representing Fractions) |
| | Fractions (Equivalent fractions) |
| | Comparing (Fractions) |
| | Ordering Fractions |
| | Fractions (as decimals and place value tenth and hundredth) |
| | Fractions (solving problems) |
| | Fraction (equivalent fractions lowest terms) |
| | Fractions (as decimals and place value tenth and hundredth) |
| | Fractions (Comparing and Ordering) |
| | Fractions (least common multiple) |
| | Fractions (Adding like denominators) |
| | Multiplying Fractions by a whole number |
| | Fractions (proper, improper, and mixed Fractions) |
| | Fractions (Adding unlike denominators) |
| | Subtracting Fractions |
| | Fractions (multiplying patterns of fractions) |
| | Fractions (Multiplying & Dividing Fractions) |
| | Solving Problems Using Fractions |
| | Multiplying and Dividing Positive Fractions |
| | Least Common Multiple & Greatest Common Factor |
| | Converting Fractions |
| | Adding and Subtracting Fractions (unlike denominator) |
| Number Theory | Number Theory (Divisibility) |
| | Number Theory (Factors) |
| | Number Theory (Multiples) |
| | Number Theory (prime/composite numbers) |
| | Number Theory (Prime Factors) |
| | Number Theory (Common greatest factors) |
| | Number Theory (Divisibilty rules) |
| Decimal Operations | Decimals (Adding and Subtracting) |
| | Decimals (Multiplication & Money Notation) |
| | Decimals (Division) |
| | Terminating and Repeating Decimals |
| Percentages | Percentages (percents & fractions) |
| | Percentages (percents & decimals) |
| | Percentages (Ratios) |
| | Percentages (Proportions) |
| | Percentages (estimating and calculating) |
| | Calculate Percentages |
| | Percentage Increase and Decrease |
| | Discounts and Markups |
| Ratios and | Interpreting and Using Ratios |
| Proportions | Using Proportions to Solve Problems |
| Positive and | Positive and Negative Numbers |
| Negative Integers | Ordering Rational Numbers |
| | Solving Problems with Integer Operations |
| | Absolute Value |
| | Adding and Subtracting Negative Numbers |
| | Multiplying and Dividing Negative Numbers |
| Exponents | Scientific Notation |
| | Rational Integer Operations and Powers |
| | Irrational Numbers |
| | Negative Whole Number Exponents |
| | Square Roots |
| | Rational Numbers and Exponent Rules |
| Money | Money Recognition |
| | Money (Values) |
| Time | Time (Reading a clock) |
| | Time - Calendar (Months) |
| | Elapsed Time |
| | Time - Calendar (Weeks) |
| Temperature | Temperature - Concept |
| | Temperature - Reading Temp. |
| Length | Comparative Vocabulary |
| | Measuring Length by Object |
| | Number Line |
| | Customary & Metric - Concepts of Length |
| | Length. Customary and Metric Units |
| | Customary - Length |
| | Customary - Converting Units of Length |
| | Customary - Comparing Units of Length |
| | Metric -- Length |
| | Metric -- Converting Units of Lengths |
| | Metric -- Comparing Metric Lengths |
| | Converting Units (More Complex) |
| Weight | Customary and Metric - Concepts of Weight |
| | Weight -- customary |
| | Weight -- Units of Measure |
| | Weight -- Converting and comparing units of weight |
| Capacity and | Customary - Capacity |
| Volume | Metric -- Capacity |
| | Capcity -- Units of Measure |
| | Customary -- Units of Capacity/volume |
| | Metric -- Comparing Metric Capacity/Volume |
| Rate | Understanding Rate |
| | Solving Problems Using Rate |
| | Comparing Rates |
| | Scale |
| | Solving Rate Problems |
| Patterns and | Simple Patterns |
| Sorting | Sorting by Common Attributes |
| | Extending Patterns |
| | Extending Linear Patterns |
| | Problem Solving (Linear Patterns) |
| Data | Simple Data Representation |
| Representation | Multiple Representations of the Same Data |
| | Features of Data Sets |
| | Problem Solving (Data Represenation) |
| Simple | Likelihood |
| Probability | Simple Probability |
| | Estimating Future Events |
| | Representing Probabilities |
| | Probability of Multiple Events |
| Outcomes | Recording Outcomes |
| | Representing Results |
| | Representing Outcomes |
| | Representing Possible Outcomes |
| Displaying Data | Interpreting Graphs |
| | Displaying Data |
| | Comparing Data (Fractions and Percents) |
| | Data Representation |
| | Scatterplots |
| Measures of | Mean, Median, and Mode |
| Central Tendency | Mean, Median, and Mode (computing) |
| | Computing Measures of Central Tendency |
| | Changing Central Tendency |
| | Outliers |
| | Use of Measures of Central Tendency |
| | Data Set Quartiles |
| Ordered Pairs | Identifying Ordered Pairs |
| | Writing Ordered Pairs |
| Samples | Samples |
| | Selecting Samples |
| | Sampling Errors |
| | Independent and Dependent Events |
| Location and | Location Vocabulary |
| Direction | Location & Direction |
| 2D Shapes | 2D Shapes (Shape Given) |
| | Comparing Shapes |
| | 2D Shapes (Name Given) |
| | Shapes -- Attributes |
| | Describing Shapes |
| | Forming Polygons |
| | Polygons |
| | Identifying Congruency Figures |
| | Symmetry |
| | Elements of Geometric Figures |
| | Translations and Reflections |
| | Solving Problems Involving Congruence |
| 3D Shapes | 3D Faces |
| | 3D Shapes |
| | Composing 3D Shapes |
| | Qualities of Three-Dimensional Figures |
| | Patterns for 3-Dimensional Figures |
| | 3D Geometric Elements |
| Triangles | Triangles -- Attributes |
| | Right Angle Knowledge |
| | Triangle Definitions |
| | Solving for Unknown Angles |
| | Pythagorean Theorem |
| Quadrilaterals | Quadrilaterals -- Attributes |
| | Quadrilateral Definitions |
| Area and | Dividing Rectangles into Squares (precursor to area/perimeter) |
| Perimeter | Area (square units shown) |
| | Area vs Perimeter (figures with the same area, different perimeters) |
| | Solving for Area vs Perimeter |
| | Area and Perimeter Word Problems |
| | Units of Measure (2D & 3D Shapes) |
| | Area of Triangles and Parallelograms |
| | Perimeter, Area, and Volume |
| | Area of Complex Figures |
| Lines | Plotting Points of a Linear Equation |
| | Horizontal Line Segment Length |
| | Vertical Line Segment Length |
| | Parallel and Perpendicular Lines |
| Circles | Qualities of a Circle |
| | Pi |
| | Calculating using Pi |
| | Angles and Angle Measurement |
| Angles | Sum of Angles |
| | Types of Angles |
| Volume and | Surface Area |
| Surface Area | Volume |
| | Volume of Triangular Prisms and Cylinders |
| | Surface Area and Volume of Complex Solids |
| Geometric | Using Variables in Geometric Equations |
| Relationships | Expressing Geometric Relationship |
| | Changes of Scale |
| Relationships | Sorting by Unlike Objects |
| | Relationships of Quantities |
| | Symbolic Unit Conversions |
| | Comm. & Assoc. Properties of Mult. |
| | Rules of Linear Patterns |
| | Equivalent Addition |
| | Equivalent Multiplication |
| Expressions and | Number Sentences (addition and subtraction) |
| Problem Solving | Symbols |
| | Number Sentences and Problems (add. & subtr.) |
| | Problem Solving (add. & subtr.) |
| | Problem Solving Using Data (add. & subtr.) |
| | Selecting Operations |
| | Mathematical Expressions using Parentheses |
| | Order of Operations (with Parentheses) |
| | Using Distributive Property |
| | Writing Algebraic Expressions |
| | Equivalent Expressions |
| | Applying Order of Operations |
| | Solving Problems Using Order of Operations |
| | Writing Expressions |
| | Using Order of Operations to Evaluate Expressions |
| | Simplifying Expressions |
| | Positive Whole Number Powers |
| | Multiplying and Dividing Monomials |
| Equations | Problem Solving with Equations/Inequalities |
| | Functional Relationships (Problem Solving) |
| | Concept of Variables |
| | Formulas |
| | Simple Equations |
| | Problem Solving and Data |
| | Solving by Substitution |
| | Solving Linear Functions |
| | Solving One-Step Linear Equations |
| | Solving One-Step Inequalities |
| | Algebraic Terminology |
| | Solving Two-Step Linear Equations |
| | Solving Multi-Step Rate Problems |
| Graphing | Coordinate Plane |
| Algebraic | Graphic Representations |
| Relationships | Graphing Functions |
| | Slope |
| | Plotting Set Ratios |

In one embodiment, ADAM uniquely assesses students to find the true instructional ability of each student. 44 Sub-tests are made up of 271 sets of math constructs. These constructs are organized linearly from easiest to hardest, as defined by instructional difficulty, and will span multiple grade levels. ADAM adapts up and down these linear sub-tests to find the instructional point of each student which is critical in diagnosing and prescribing how to help students. In other words, when examining each of the 44 sub-tests, ADAM continues until it knows exactly where instruction should begin within each. An example of the linear nature of each sub-test can be illustrated by the multiplication sub-test. It is made up of 9 constructs that start with “grouping and repeated addition,” then go onto “single digit multiplication” progress to “2 and 3 digit by 2 digit multiplication,” and finally end with “commutative, associative, distributed properties.” These constructs span grade levels 3 to 5.

In contrast, standards based assessments will take items at the same grade level across all sub-tests at once. Then at best they make quasi-diagnostic or summative conclusions such as this student is below grade level in “4^{th} grade fractions” or “4^{th} grade measurement” and is at the X percentile. Standards based assessments are summative in nature because they are making summary conclusions about students at a higher level which is usually less than 44 sub-tests and primarily focus on comparing groups of students to other groups within very generalized areas of mathematics. Thus, for example:

Standards Model of Assessment
Math constructs are organized by grade levels and into the 5 major math strands listed in each column heading
Students are given a sampling of single test questions/items in constructs within their grade level.
Summative results span entire test or within general math strands listed below.

| Grade | Numbers & Operations | Meaurement | Data Analysis | Geometry | Algebraic Thinking |
|---|---|---|---|---|---|
| K | Math Construct 1 Item | Math Construct 1 Item | Math Construct 1 Item | Math Construct 1 Item | Math Construct 1 Item |
| K | Math Construct 2 Item | Math Construct 2 Item | Math Construct 2 Item | Math Construct 2 Item | Math Construct 2 Item |
| K | Math Construct 3 Item | Math Construct 3 Item | Math Construct 3 Item | Math Construct 3 Item | Math Construct 3 Item |
| K | . . . | . . . | . . . | . . . | . . . |
| K | Math Construct X Item | Math Construct X Item | Math Construct X Item | Math Construct X Item | Math Construct X Item |
| 1 | Math Construct 1 Item | Math Construct 1 Item | Math Construct 1 Item | Math Construct 1 Item | Math Construct 1 Item |
| 1 | Math Construct 2 Item | Math Construct 2 Item | Math Construct 2 Item | Math Construct 2 Item | Math Construct 2 Item |
| 1 | Math Construct 3 Item | Math Construct 3 Item | Math Construct 3 Item | Math Construct 3 Item | Math Construct 3 Item |
| 1 | . . . | . . . | . . . | . . . | . . . |
| 1 | Math Construct X Item | Math Construct X Item | Math Construct X Item | Math Construct X Item | Math Construct X Item |
| 2 | Math Construct 1 Item | Math Construct 1 Item | Math Construct 1 Item | Math Construct 1 Item | Math Construct 1 Item |
| 2 | Math Construct 2 Item | Math Construct 2 Item | Math Construct 2 Item | Math Construct 2 Item | Math Construct 2 Item |
| 2 | Math Construct 3 Item | Math Construct 3 Item | Math Construct 3 Item | Math Construct 3 Item | Math Construct 3 Item |
| 2 | . . . | . . . | . . . | . . . | . . . |
| 2 | Math Construct X Item | Math Construct X Item | Math Construct X Item | Math Construct X Item | Math Construct X Item |
| . . . | . . . | . . . | . . . | . . . | . . . |

In another embodiment, ADAM makes decisions about mastery of constructs (multiple constructs make up a sub-test) by grouping 3 or more actual test questions together. Uncovering actual individual student-performance on these sets of items determines mastery or non-mastery at ADAM's 271 construct level. Rather than report student diagnosis based on individual test questions that have statistical values derived from group testing, ADAM determines what each student can or cannot do at the construct level which is a set of items. This is unique to ADAM and critical in a diagnostic assessment because individual student diagnostic assessments like ADAM must reliably report on mastery at this very granular construct level for each student. See the figure below.

ADAM'S Model of Assessment
Math constructs are organized by Sub-Tests
Students are tested based on their performance and ability regardless of the grade level of the test questions

| Grade | Sub-Test 1 | Sub-Test 2 | Sub-Test 3 | . . . | Sub-Test 44 |
|---|---|---|---|---|---|
| K | Math Construct 1 Set | Math Construct 1 Set | Math Construct 1 Set | . . . | Math Construct 1 Set |
| K | Math Construct 2 Set | Math Construct 2 Set | Math Construct 2 Set | . . . | Math Construct 2 Set |
| K | Math Construct 3 Set | Math Construct 3 Set | Math Construct 3 Set | . . . | Math Construct 3 Set |
| K | . . . | . . . | . . . | . . . | . . . |
| K | Math Construct X Set | Math Construct X Set | Math Construct X Set | . . . | Math Construct X Set |
| 1 | Math Construct 1 Set | Math Construct 1 Set | Math Construct 1 Set | . . . | Math Construct 1 Set |
| 1 | Math Construct 2 Set | Math Construct 2 Set | Math Construct 2 Set | . . . | Math Construct 2 Set |
| 1 | Math Construct 3 Set | Math Construct 3 Set | Math Construct 3 Set | . . . | Math Construct 3 Set |
| 1 | . . . | . . . | . . . | . . . | . . . |
| 1 | Math Construct X Set | Math Construct X Set | Math Construct X Set | . . . | Math Construct X Set |
| 2 | Math Construct 1 Set | Math Construct 1 Set | Math Construct 1 Set | . . . | Math Construct 1 Set |
| 2 | Math Construct 2 Set | Math Construct 2 Set | Math Construct 2 Set | . . . | Math Construct 2 Set |
| 2 | Math Construct 3 Set | Math Construct 3 Set | Math Construct 3 Set | . . . | Math Construct 3 Set |
| 2 | . . . | . . . | . . . | . . . | . . . |
| 2 | Math Construct X Set | Math Construct X Set | Math Construct X Set | . . . | Math Construct X Set |
| . . . | . . . | . . . | . . . | . . . | . . . |
| 7 | Math Construct 1 Set | Math Construct 1 Set | Math Construct 1 Set | . . . | Math Construct 1 Set |
| 7 | Math Construct 2 Set | Math Construct 2 Set | Math Construct 2 Set | . . . | Math Construct 2 Set |
| 7 | Math Construct 3 Set | Math Construct 3 Set | Math Construct 3 Set | . . . | Math Construct 3 Set |
| 7 | . . . | . . . | . . . | . . . | . . . |
| 7 | Math Construct X Set | Math Construct X Set | Math Construct X Set | . . . | Math Construct X Set |

In comparison, standards-based assessments make conclusions based on large samples of data to predict student outcome. This is fine for group reports or when making generalizations about a student but for individual prescriptive student diagnosis, one must assume the student is not the norm. Often students who are not at grade level are not the norm, thus making conclusions that compare these students to the norm is intrinsically faulty. Standards based assessments will say that 80% of kids who miss construct A do not get construct B. So they don't bother to test construct B. But diagnostic assessments cannot be based on statistical assumptions because they are trying to find out “why” a particular student may be struggling and the reason often has to do with the student being unique.

In yet another embodiment, ADAM's adaptive logic uniquely follows the following formulas for adjusting up and down within a sub-test and for early termination of a set of test items within a construct:
Mastery of a construct is determined by a score of 66% correct or higher as a student is given the items in that construct. If mastery cannot be attained after a few questions, the construct is marked as non-mastered and ADAM moves on. This adaptive logic reduces the number of test items given to a student and thus reduces test-fatigue. Furthermore, if mastery is determined before all items in the set are given, the set will be stopped early, the construct marked as mastered, and ADAM will move on.
Jump sizes are how many constructs up or down the assessment will go after a construct is determined to be mastered or non-mastered. This jump size is uniquely determined by the number of constructs defined at a grade level in any particular sub-test.
In any particular sub-test:
   if total number of constructs are 1 or 2 at any single grade level jump size is +1 or −1
   if total number of constructs are 3 or 4 at any single grade level jump size is +2 or −2.
   if total number of constructs are 5 or greater at any single grade level, jump size is +3 or −3.
   Reduce jump up or down if it will overjump a failed construct.
   Reduce jump down if it will overjump a mastered construct.
   Reduce jump down if it will exceed the lowest or highest construction in a sub-test

In yet another embodiment, ADAM attempts to reduce the chance that students will guess at a question and get it correct by virtue of the question being multiple-choice by adding an addition choice that turns on when a construct and its set of test items are above the student's grade level. Under these conditions, ADAM uniquely turns on a 5^{th} choice labeled as “I don't know.” If the student is given test items that are at his or her grade level or lower, this choice will not turn on.

In another embodiment, ADAM uniquely changes the test interface that a student is given by changing the interface of the test based on a student's grade level. The actual test items which include, the question, multiple answer choices, and audio files are not changed. This separation of the interface from the actual test items in online assessment increases engagement of the student being assessed and thus increases test reliability.

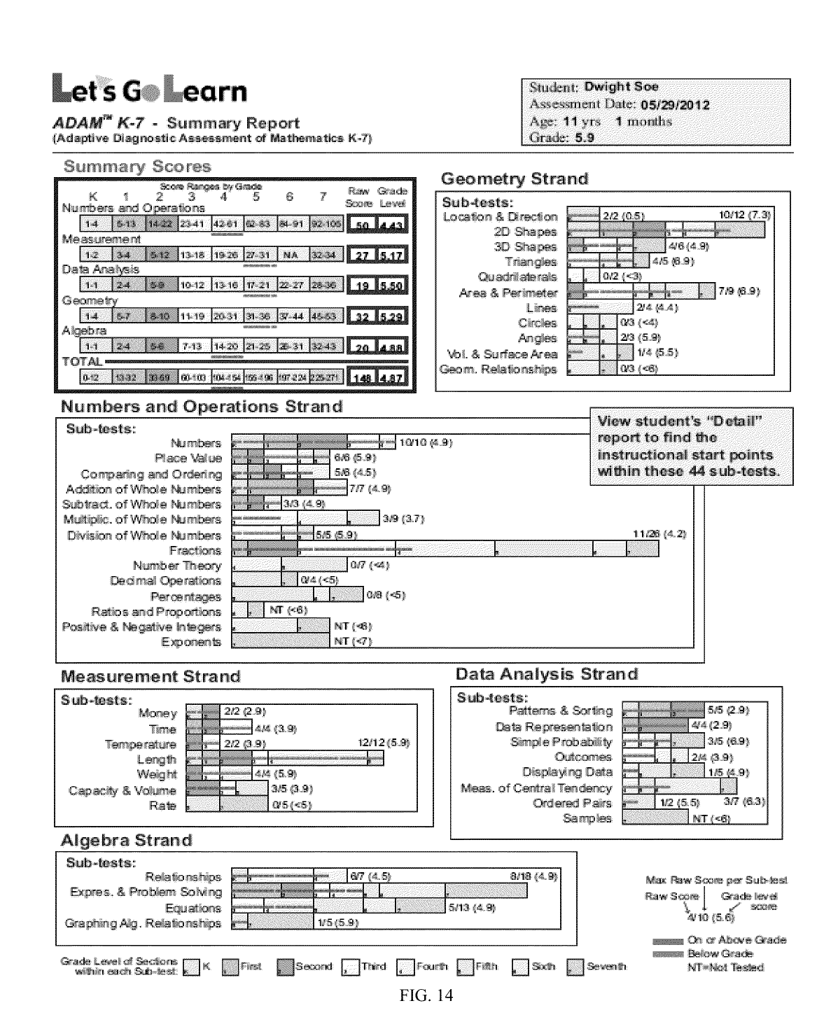

Highly informative and diagnostic reports are generated automatically at the completion of each assessment. FIG. 14 shows the summary ADAM report. A detailed report is also available. These are used to provide prescriptive instruction for each student.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

The above system can be implemented as one or more computer programs. Each computer program is tangibly stored in a machine-readable storage media or device (e.g., program memory or magnetic disk) readable by a general or special purpose programmable computer or intangibly stored in a cloud virtual storage format, for configuring and controlling operation of a computer or virtual computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical or virtual quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method to serve fresh media content for a plurality of student computers coupled to a local area network (LAN) with a router coupled to the Internet to access multimedia educational content originally stored on a remote server, the method comprising:
providing rapid access to the education content with minimal traffic from the Internet by:
attaching a local server to the LAN to locally store educational multimedia content and periodically synchronizing contents of the local server with contents on the remote server;
determining requests for Internet contents and directing the requests in real-time to directories on the local server by creating proxies and reverse proxies to force web pages to route to the local server;
presenting the multimedia educational content to the students and testing for student comprehension of the multimedia content and presenting additional multimedia educational content based on student performance on earlier questions, wherein the presenting further comprises:
redirecting predetermined multimedia content requests to the local server; and
forwarding other requests to another server or to the Internet;
periodically checking content freshness between the local server and a remote server;
if a stale content exists on the local server, replacing the stale content with a fresh content from the remote server;
serving the fresh content from the local server; and
testing the student by:
presenting a new concept to the student through a multimedia presentation;
testing the student on the concept at a predetermined testing level;
collecting test results for one or more concepts into a test result group;
performing a formative diagnosis on the test result group to provide information to guide individualized instruction; and
adaptively modifying the predetermined testing level based on the diagnosis of each testing group and repeating tests at the adaptively modified predetermined testing level for a plurality of sub-tests.

2. The method of claim 1, comprising providing educational adaptive diagnostic assessment of student performance.

3. The method of claim 1, comprising adaptively testing a student by:
receiving one or more parameters for an assessment and one or more sets of test questions for a sub-test;
selecting a set of test questions from the sub-test;
presenting the selected set of test questions to the student and collecting responses thereto;
generating a score for the responses to a completed set;
applying the score to select either the current set of questions or a new set of test questions; and
using a final score for the sub-test to select a new set of questions in a subsequent sub-test.

4. The method of claim 3, wherein the parameters comprise one or more of: a number of subtests; a number of sets of questions for each subtest; a number of questions per set of questions; an assessment starting point; a grade level; a student age; a prior score; a parameter specifying a transition between subtests; a parameter specifying a movement within a subtest; a termination condition for each subtest; a termination condition for the assessment; a graphical interface parameter; an audio parameter; a summary score formula.

5. The method of claim 1, wherein a student responds to test questions through a teacher management application.

6. The method of claim 1, wherein the student responds to test questions through a third party application having a security key code.

7. The method of claim 1, wherein the student begins the assessment based on one of: a grade level, an age, a student type, a previous test score from a completed assessment.

8. A system, comprising:
a remote server to store fresh content;
a wide area network coupled to the remote server; and
a local server coupled to the wide area network, the local server periodically replacing stale content with fresh content from the remote server and serving the fresh content in response to a request from one or more clients coupled to the local server, wherein proxies and reverse proxies route web pages to the local server for presenting multimedia educational content to students and testing for student comprehension of the multimedia content and presenting additional multimedia educational content based on student performance on earlier questions, wherein predetermined multimedia content requests are sent to the local server;
other requests are forwarded to another server or to the Internet; and
means for testing the student by:
presenting a new concept to the student through a multimedia presentation;
testing the student on the concept at a predetermined testing level;
collecting test results for one or more concepts into a test result group;
performing a formative diagnosis on the test result group to provide information to guide individualized instruction; and
adaptively modifying the predetermined testing level based on the diagnosis of each testing group and repeating (a)-(d) at the adaptively modified predetermined testing level for a plurality of sub-tests.

9. The system of claim 8, comprising:
means for receiving one or more parameters for an assessment and one or more sets of test questions for a sub-test;
means for selecting a set of test questions from the sub-test;
means for presenting the selected set of test questions to the student and collecting responses thereto;
means for generating a score for the responses to a completed set;
means for applying the score to select either the current set of questions or a new set of test questions; and
means for using a final score for the sub-test to select a new set of questions in a subsequent sub-test.

10. The system of claim 9, wherein the parameters comprise one or more of: a number of subtests; a number of sets of questions for each subtest; a number of questions per set of questions; an assessment starting point; a grade level; a student age; a prior score; a parameter specifying a transition between subtests; a parameter specifying a movement within a subtest; a termination condition for each subtest; a termination condition for the assessment; a graphical interface parameter; an audio parameter; a summary score formula.

11. The system of claim 8, comprising means for modifying a user's response by directing matching requests to the local server and forwarding non-matching requests to the Internet.

12. The system of claim 8, comprising means for controlling traffic using one or more proxies.

13. The system of claim 8, comprising means for providing one or more reverse proxies.

14. The system of claim 8, comprising means for forcing certain requests to route through the local server.

15. The system of claim 8, comprising means for communicating through a primary local area network (LAN) directly coupled to the Internet.

16. The system of claim 8, wherein the local server is coupled to the LAN.

17. The system of claim 8, comprising means for communicating through one or more sub-LANs coupled to the primary LAN.

18. The system of claim 8, wherein the local server is coupled to one of the sub-LANs.
